(19) United States
(12) Patent Application Publication
(10) Pub. No.: US 2013/0008252 A1
(43) Pub. Date: Jan. 10, 2013

(54) DETECTION OF CRACKS ON METAL BELLOWS OF VALVES

(75) Inventors: Armin Ott, Riekofen (DE); Martin Zierer, Brennberg (DE)

(73) Assignee: KRONES AG, Neutraubling (DE)

(21) Appl. No.: 13/541,506

(22) Filed: Jul. 3, 2012

(30) Foreign Application Priority Data
Jul. 8, 2011 (DE) 10 2011 078 881.6

(51) Int. Cl. G01N 29/14; G01H 1/14

(52) U.S. Cl. 73/587

(57) ABSTRACT

The present disclosure relates to a method for detecting a damage or contamination of a valve bellows, comprising the steps of: causing the valve bellows to oscillate, sensing the oscillations with a sensor and outputting a sensor signal generated by the oscillations, and comparing at least one sensor signal value with at least one reference value. The disclosure further relates to an apparatus comprising a valve with a valve bellows, a sensor for sensing oscillations of the valve bellows and for outputting a sensor signal generated by the oscillations, and a comparator circuit, such as a microprocessor, for comparing at least one sensor signal value with at least one reference value.

### CROSS-REFERENCE TO RELATED APPLICATIONS

This application claims foreign priority benefits under 35 U.S.C. §119(a)-(d) to German patent application number DE 10 2011 078 881.6, filed Jul. 8, 2011, which is incorporated by reference in its entirety.

### TECHNICAL FIELD

The present disclosure relates to a method for detecting a damage or contamination of a valve bellows as well as to a corresponding apparatus.

### BACKGROUND

In filling processes performed in the beverage and food industry valves are used. For hygienic reasons a bellows is frequently found inside these valves, especially a metal bellows consisting of one or several layer(s). By means of such a bellows the fluids, whose flow rate is regulated by these valves, can be reliably separated, for example, from lubricants on points of friction. However, permanent stress, pressure blows or faulty fabrication may cause damage to the bellows, e.g., cracks in the bellows may occur, with the consequence that the product, or also a cleaning agent, can settle in the gaps or cracks, resulting in an unhygienic condition of the valve.

So far, a damaged bellows is detected either by disassembling the valve and visually inspecting the bellows, or liquid escapes through a leakage space, the discovery of which likewise indicates a leak. This way of inspecting valve bellows is complicated, however, and takes time.

### SUMMARY

Given these disadvantages of the prior art it is, therefore, an object of the present disclosure to avoid these disadvantages and to provide a method and a corresponding apparatus for detecting a possible damage of the valve bellows without a direct visual inspection of the valve. Preferably, this inspection should be automatable.

The aforementioned object is achieved by a method for detecting a damage or contamination of a valve bellows, comprising the steps of: causing the valve bellows to oscillate, sensing the oscillations with a sensor and outputting a sensor signal generated by the oscillations, and comparing at least one sensor signal value with at least one reference value. Each component part, hence also the valve bellows, has an independent oscillation pattern, especially if it is caused to oscillate in a defined manner. This oscillation pattern of the bellows varies if the condition of the bellows changes due to a contamination or damage. By sensing these oscillations with a sensor to generate a sensor signal, values derived from the sensor signal can be compared with a reference value so as to establish deviations from the standard.

The method according to the disclosure can be developed further by recording the at least one reference value when the valve is put into operation. This has the advantage that the reference value is obtained in the installed state of the valve, so that possible ambient influences such as resonances or attenuations are taken into account.

Another further development is that the at least one reference value comprises a reference curve with a plurality of reference values. Such a reference curve can be provided, for example, by the time-dependent oscillation amplitude and/or oscillation frequency, wherein multiple sensor signal values obtained at different times can be compared with the corresponding time-dependent reference values of the reference curve.

According to another further development of the method for detecting a damage or contamination of a valve bellows the additional step of detecting a damage or contamination may be carried out if the at least one sensor signal value deviates from the at least one reference value by a predetermined amount. By specifying a predetermined amount of the deviation (e.g., also in the form of an absolute value of the deviation) a simple instruction for detecting a damage or contamination of the valve bellows is defined.

In another further development the step of causing the valve bellows to oscillate may be accomplished by opening and closing the valve. For example, the valve disc is briefly lifted and then moved back against its stop. Specifically the hitting against the stop causes the valve bellows to oscillate. The oscillations can be sensed by the sensor. In connection with a time dependence of the sensor signal and sensor signal values derived therefrom the hitting time also defines a starting time.

The method according to this further development may, again, be developed further by recording the at least one reference value when the valve is put into operation, also by opening and closing the valve. In this way, a reference value or a reference value curve is recorded, which is performed under the same conditions as the later measurement.

Preferably, the method can be carried out after the valve has been cleaned because the valve bellows should then be free from deposits.

The method according to the disclosure, or one of the further developments, may be carried out such that a frequency analysis of the sensor signal is performed to compare the at least one sensor signal value with at least one reference value. Thus, for example, the measurement can be carried out at a particularly characteristic frequency (natural frequency) of the valve bellows. Moreover, comparisons of signal values with reference values at different frequencies are possible as well.

The above-mentioned object is further provided by an apparatus, comprising: a valve with a valve bellows, a sensor for sensing oscillations of the valve bellows and for outputting a sensor signal generated by the oscillations, and a comparator circuit, specifically a microprocessor, for comparing at least one sensor signal value with at least one reference value. The apparatus according to the disclosure serves to carry out the method according to the disclosure. The advantages of the apparatus according to the disclosure over the prior art correspond to those already recited in connection with the method according to the disclosure, so that a repetition thereof is waived.

The apparatus according to the disclosure can be developed further by providing a data memory for storing reference values, specifically a reference curve, and/or limit values.

Another further development is that one or more connecting lines are provided from the sensor to the comparator circuit, wherein the connecting lines are preferably passed over a control head of the valve. Thus, the sensor signals can be transmitted to the comparator circuit for the evaluation thereof if the sensor is arranged, for example, inside the valve bellows.

According to another further development the comparator circuit may further be adapted to carry out a frequency analysis of the sensor signal.

Other features and exemplary embodiments as well as advantages of the present disclosure will be explained in more detail below by means of a drawing. It will be appreciated that the embodiments do not limit the scope of the present disclosure. It will also be appreciated that some or all of the features described below may also be combined with each other in a different way.

### DESCRIPTION OF THE DRAWING

FIG. 1 represents an embodiment of the apparatus according to the disclosure.

### DETAILED DESCRIPTION

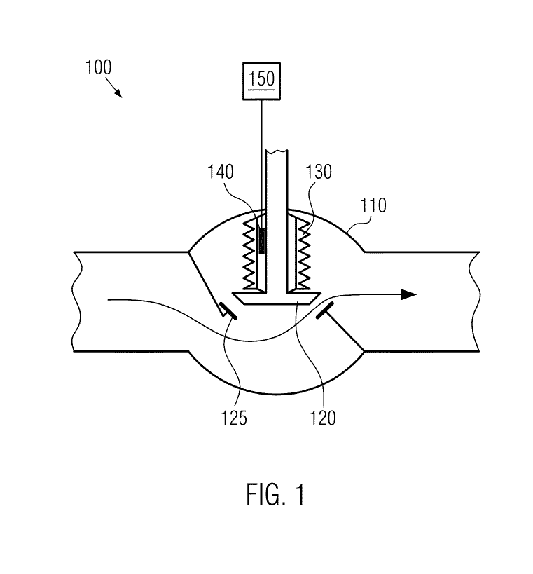

FIG. 1 shows an embodiment 100 of the apparatus according to the disclosure.

The apparatus 100 according to the disclosure comprises a valve 110 with a valve bellows 130, a sensor 140 sensing oscillations of the bellows 130 and outputting a sensor signal generated by the oscillations to a comparator circuit 150, the comparator circuit here being a microprocessor 150 which compares a sensor signal value with a reference value. In this example, the sensor 140 is mounted on an inner side of the bellows 130. The valve bellows 130 is made of metal. When the valve is put into operation a reference curve of the functional bellows 130 is recorded and stored as a reference. To this end, for example, the valve disc 120 may be briefly lifted and then moved back against its stop 125. The oscillations of the bellows 130 are sensed by the sensor 140, e.g., in the form of a piezoelectric sensor, and are transformed into signals.

A measurement for the detection of possible damages, and/or contaminations of the bellows which cannot be removed, can then be carried out, for example, after a cleaning cycle in which the valve and in particular the bellows are cleaned. To this end, the bellows is caused to oscillate in the same way as is done for the recording of the reference value/reference values, by lifting the valve disc and returning it to the stop 125. If a comparison of the measured values shows that the deviation, defined for example by limit values, from the normal condition, i.e., from the stored reference curve, is too great, there is a variation in the form of a damage or a contamination.

By this, forthcoming damages may be discovered, and the result may be considered, for example, in a maintenance plan. If multilayer bellows are provided, there may be not yet an escape of liquid if only one layer of the bellows is damaged. Nevertheless, this damage may result in unhygienic deposits, which are detected by this system.

In this embodiment, the sensor 140 is disposed inside the bellows. It may also be disposed outside the valve housing, however, with the valve body serving as an amplifier. Another possibility is the arrangement of the sensor in the valve, but outside the bellows.

Summarizing, the present disclosure provides for a method and an apparatus for the detection in particular of cracks on metal bellows of valves. According to the disclosure the metal bellows is caused to oscillate, and the oscillation pattern is detected by a sensor and compared with a recorded oscillation pattern. By this, it can be detected whether the bellows oscillates differently as compared to when it was put into operation and, consequently, has to be classified as being damaged or contaminated.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for detecting damage or contamination of a valve bellows, the method comprising:
causing the valve bellows to oscillate;
sensing oscillations of the valve bellows with a sensor and outputting a sensor signal generated by the oscillations; and
comparing at least one sensor signal value associated with the sensor signal with at least one reference value.

2. The method according to claim 1 further comprising recording the at least one reference value when the valve is put into operation.

3. The method according to claim 1 wherein the at least one reference value comprises a reference curve with a plurality of reference values.

4. The method according to claim 1 further comprising detecting damage or contamination if the at least one sensor signal value deviates from the at least one reference value by a predetermined amount.

5. The method according to claim 1 wherein the step of causing the valve bellows to oscillate comprises opening and closing the valve.

6. The method according to claim 5 further comprising recording the at least one reference value when the valve is put into operation and opened and closed.

7. The method according to claim 1 wherein the method is carried out after the valve has been cleaned.

8. The method according to claim 1 wherein a frequency analysis of the sensor signal is performed to compare the at least one sensor signal value with at least one reference value.

9. An apparatus comprising:
a valve with a valve bellows;
a sensor for sensing oscillations of the valve bellows and for outputting a sensor signal corresponding to the oscillations; and
a comparator circuit for comparing at least one sensor signal value associated with the sensor signal with at least one reference value.

10. The apparatus according to claim 9 further comprising a data memory for storing the at least one reference value.

11. The apparatus according to claim 9 further comprising one or more connecting lines from the sensor to the comparator circuit.

12. The apparatus according to claim 11 wherein the valve has a control head, and the one or more connecting lines pass over the control head.

13. The apparatus according to claim 9 wherein the comparator circuit is further adapted to carry out a frequency analysis of the sensor signal.

14. A method for detecting damage or contamination of a valve bellows, the method comprising:
sensing oscillations of the valve bellows with a sensor;
outputting a sensor signal corresponding to the oscillations; and
comparing at least one sensor signal value associated with the sensor signal with at least one reference value.

15. The method according to claim 14 further comprising establishing the at least one reference value when the valve is put into operation.

16. The method according to claim 14 wherein the at least one reference value is established when the valve is initially put into operation, and the sensing is performed after the valve has been used and cleaned.

17. The method according to claim 14 wherein damage or contamination of the valve bellows is detected if the at least one sensor signal value deviates from the at least one reference value by a predetermined amount.

18. The method according to claim 14 wherein the at least one reference value comprises a reference curve with a plurality of time-dependent reference values, and the comparing step comprises comparing multiple sensor signal values obtained at different times with the time-dependent reference values of the reference curve.
